(19) United States
(12) Patent Application Publication
(10) Pub. No.: US 2025/0285173 A1
(43) Pub. Date: Sep. 11, 2025

(54) INFORMATION PROCESSING SYSTEM

(71) Applicant: TOSHIBA TEC KABUSHIKI KAISHA, Tokyo (JP)

(72) Inventors: Ryo Wataguro, Setagaya Tokyo (JP); Natsuki Suzuta, Ota Tokyo (JP); Shigeru Sato, Yokohama Kanagawa (JP); Naoki Hoshino, Hasuda Saitama (JP); Keiji Suzuki, Ota Tokyo (JP)

(21) Appl. No.: 18/947,028

(22) Filed: Nov. 14, 2024

(30) Foreign Application Priority Data
Mar. 8, 2024 (JP) 2024-035801

(51) Int. Cl. G06Q 30/0601; G06Q 30/0251; G06V 10/74

(52) U.S. Cl. CPC G06Q 30/0643; G06Q 30/0255; G06V 10/761

(57) ABSTRACT

An information processing system is provided that can efficiently support a consumer in acquiring a specific commodity image. According to one embodiment, the information processing system includes a first acquisition unit, a second acquisition unit, a search unit, an evaluation unit, and a presentation unit. The first acquisition unit acquires customer information including information related to an interest tendency of a customer. The second acquisition unit acquires commodity information related to a target commodity in a purchase consideration of the customer. The search unit searches for, based on the commodity information, a related content including an image related to the target commodity from a plurality of contents including images stored in an external device. The evaluation unit evaluates a priority of the searched related content based on the customer information. The presentation unit presents the related content to the customer according to the priority.

### CROSS-REFERENCE TO RELATED APPLICATION

This application is based upon and claims the benefit of priority from Japanese Patent Application No. 2024-035801, filed on Mar. 8, 2024, the entire contents of which are incorporated herein by reference.

### FIELD

Embodiments described herein relate to an information processing system and an information processing method.

### BACKGROUND

In the related art, a consumer searches for a commodity using an electronic commerce (EC) site or a social networking service (SNS). For example, the consumer may perform an image search based on a commodity name or a brand name.

In an image search based on a commodity name or a brand name, an image of an image requested by a consumer may not be obtained. In response to this, there is known a technique of supporting a consumer to understand his or her own sensitivity and value and providing information related to clothing and fashion to the consumer.

However, the information proposed in the related art may not be linked to a specific commodity image requested by the consumer. In this case, the consumer cannot acquire a specific commodity image, and there is a chance that purchase consideration of the consumer may be hindered.

### DESCRIPTION OF THE DRAWINGS

FIG. 1 is a block diagram showing an example of a configuration of a purchase support system according to an embodiment.

FIG. 2 is a block diagram showing an example of a configuration of a customer terminal.

FIG. 3 is a block diagram showing an example of a configuration of a display device.

FIG. 4 is a block diagram showing an example of a configuration of a management server.

FIG. 5 is a diagram showing an example of a data structure of a customer information DB.

FIG. 6 is a diagram showing an example of a data structure of a commodity name DB.

FIG. 7 is a diagram showing an example of a data structure of a consideration list.

FIG. 8 is a block diagram showing an example of a configuration of a store server.

FIG. 9 is a diagram showing an example of a data structure of a related information DB.

FIG. 10 is a block diagram showing an example of a functional configuration of an information processing system.

FIG. 11 is a flowchart showing an example of processing executed by the purchase support system.

### DETAILED DESCRIPTION

In general, according to one embodiment, an information processing system capable of efficiently supporting acquisition of a specific commodity image by a consumer.

According to one embodiment, an information processing system includes a first acquisition unit, a second acquisition unit, a search unit, an evaluation unit, and a presentation unit. The first acquisition unit acquires customer information including information related to an interest tendency of a customer. The second acquisition unit acquires commodity information related to a target commodity in a purchase consideration of the customer. The search unit searches for, based on the commodity information, a related content including an image related to the target commodity from a plurality of contents including images stored in an external device. The evaluation unit evaluates a priority of the searched related content based on the customer information. The presentation unit presents the related content to the customer according to the priority.

Hereinafter, an embodiment of an information processing system will be described in detail with reference to the accompanying drawings. The embodiment described below is an embodiment of an information processing system, and does not limit a configuration, specification, and the like thereof.

### First Embodiment

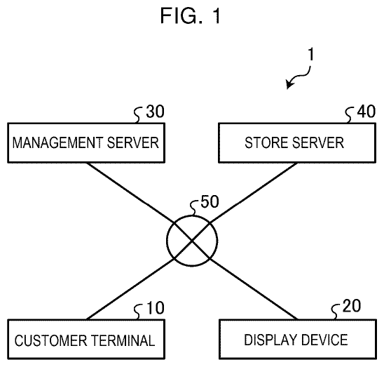

FIG. 1 is a diagram showing an example of a purchase support system 1 according to an embodiment. The purchase support system 1 is a system that supports a purchase consideration of a customer by presenting to the customer, who is a consumer, an image related to a commodity that the customer is considering purchasing.

In the present embodiment, the purchase support system 1 will be described that supports a customer in purchase consideration by presenting to the customer an image related to a clothing item such as clothes as a commodity purchased by the customer in a store. However, the purchase support system 1 is not limited to the clothing item, and may present to a customer an image related to a decoration, may present an image related to shoes, or may present an image of another commodity.

The purchase support system 1 includes a customer terminal 10, a display device 20, a management server 30, and a store server 40. The customer terminal 10, the display device 20, the management server 30, and the store server 40 are communicably connected via a network 50.

The purchase support system 1 shown in FIG. 1 includes one customer terminal 10, one display device 20, one management server 30, and one store server 40. However, the number of the customer terminals 10, the display devices 20, the management server 30, and the store servers 40 may be freely changed. Further, the purchase support system 1 may include a device or a system not shown in FIG. 1.

The customer terminal 10 is a device operated by the customer. For example, the customer terminal 10 is a device such as a smartphone, a tablet terminal, or a personal computer. The customer terminal 10 receives, from the customer, various inputs related to a purchase support service to be provided to the customer.

The display device 20 is a device having a function of displaying various images. For example, the display device 20 is installed in a fitting room or the like of a store. The display device 20 displays, in the fitting room of the store, an image related to a commodity which is a purchase consideration target by a customer.

The display device 20 may be, for example, a digital signage device, a tablet terminal, or a digital mirror device having a mirror function of reflecting visible light to show an appearance of the customer or the like, and a display function of displaying various images.

The management server 30 is a device that manages the purchase support system 1. For example, the management server 30 searches for an image related to a target commodity that the customer is considering purchasing for various types of social networking service (SNS). The management server 30 displays the image related to the searched target commodity on the display device 20. For example, the management server 30 is an information processing device such as a server device or a personal computer.

The store server 40 is a device that manages commodity information related to commodity. For example, the store server 40 is provided in a store where the customer stays. In this case, the store server 40 manages, for example, information indicating an inventory status, an arrival schedule, and a campaign (sale or the like) of a commodity handled in the store. For example, the store server 40 is an information processing device such as a server device or a personal computer.

The store server 40 may be a device that manages information indicating an inventory status, an arrival schedule, a campaign, and the like of a commodity in an electronic commerce (EC) site.

Next, a hardware configuration of each device included in the purchase support system 1 will be described. The hardware configuration of each device described below is an example, and the hardware configuration of each device is not limited to the following configuration.

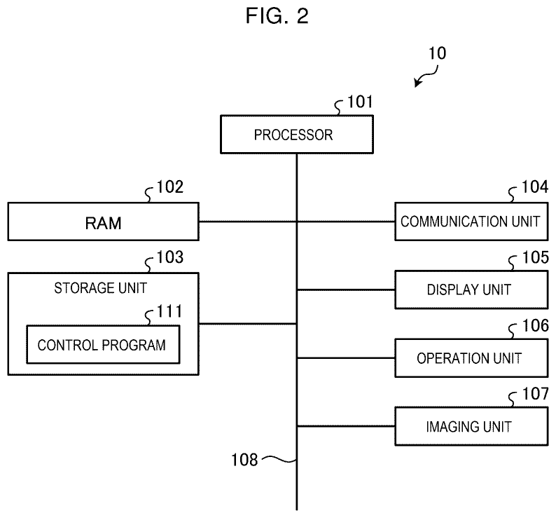

FIG. 2 is a diagram showing an example of a hardware configuration of the customer terminal 10 according to an embodiment. The customer terminal 10 includes a processor 101, a random access memory (RAM) 102, a storage unit 103, a communication unit 104, a display unit 105, an operation unit 106, and an imaging unit 107. These units are connected via an internal bus 108.

The processor 101 is a processing circuit that controls an operation of the customer terminal 10 such as a central processing unit (CPU). The RAM 102 is a storage medium that temporarily stores various programs and various types of data. The processor 101 executes a control program 111 and the like stored in the storage unit 103 using the RAM 102 as a work area (working region).

The storage unit 103 is an auxiliary storage device such as a hard disk drive (HDD), a solid state drive (SSD), or a flash memory. The storage unit 103 stores the control program 111. The control program 111 is a program for implementing functions of an operating system and the customer terminal 10. The control program 111 includes a program for implementing characteristic functions according to the present embodiment.

The communication unit 104 is a communication device such as a network interface card. For example, the communication unit 104 executes communication via the network 50.

The display unit 105 is a display device such as a liquid crystal display or an organic electro luminescence (EL) display.

The operation unit 106 is an input device that receives various operations from, for example, a keyboard, a mouse, and a touch panel provided in the display unit 105.

The imaging unit 107 is a digital camera including an imaging element such as a charge coupled device (CCD) or a complementary metal oxide semiconductor (CMOS).

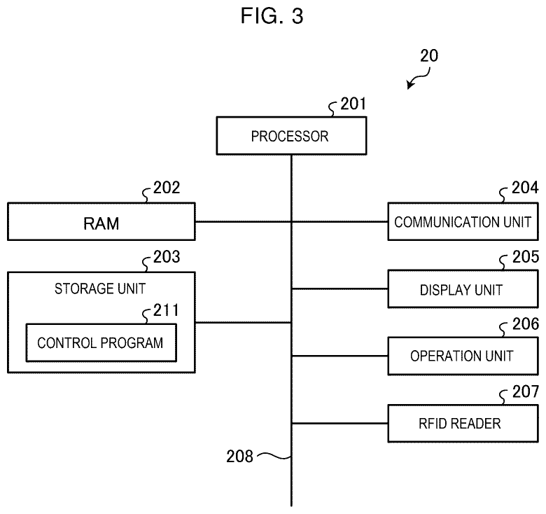

FIG. 3 is a diagram showing an example of a hardware configuration of the display device 20 according to the embodiment. The display device 20 includes a processor 201, a RAM 202, a storage unit 203, a communication unit 204, a display unit 205, an operation unit 206, and an RFID reader 207. These units are connected via an internal bus 208.

The processor 201 is a processing circuit that controls an operation of the display device 20 such as a CPU. The RAM 202 is a storage medium that temporarily stores various programs and various types of data. The processor 201 executes a control program 211 and the like stored in the storage unit 203 using the RAM 202 as a work area (working region).

The storage unit 203 is an auxiliary storage device such as an HDD, an SSD, or a flash memory. The storage unit 203 stores the control program 211. The control program 211 is a program for implementing functions of the operating system and the display device 20. The control program 211 includes a program for implementing characteristic functions according to the present embodiment.

The communication unit 204 is a communication device such as a network interface card. For example, the communication unit 204 performs communication via the network 50.

The display unit 205 is a display device such as a liquid crystal display or an organic EL display.

The operation unit 206 is an input device that receives various operations from, for example, hardware buttons and a touch panel provided in the display unit 205.

The RFID reader 207 is a device that reads an RFID tag attached to a commodity. For example, the RFID reader 207 is provided on a rear surface (surface opposite to a surface on which an image is displayed) of the display unit 205.

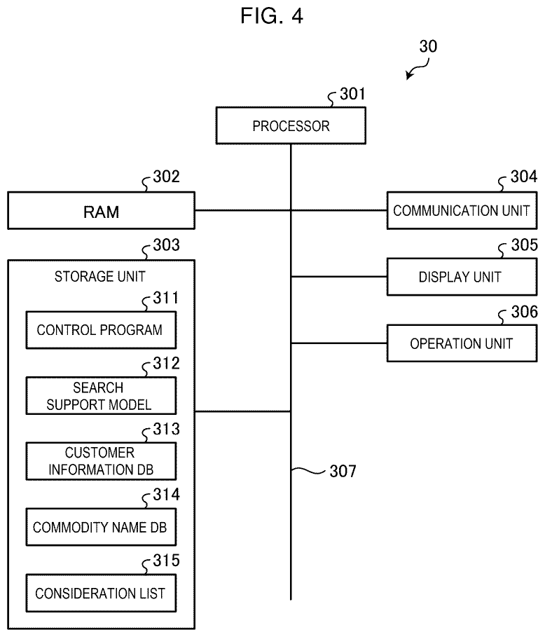

FIG. 4 is a diagram showing an example of a hardware configuration of the management server 30 according to the first embodiment. The management server 30 includes a processor 301, a RAM 302, a storage unit 303, a communication unit 304, a display unit 305, and an operation unit 306. These units are connected via an internal bus 307.

The processor 301 is a processing circuit that controls an operation of the management server 30 such as a CPU. The RAM 302 is a storage medium that temporarily stores various programs and various types of data. The processor 301 executes a control program 311 and the like stored in the storage unit 303 using the RAM 302 as a work area (working region).

The storage unit 303 is an auxiliary storage device such as an HDD, an SSD, or a flash memory. For example, the storage unit 303 stores the control program 311, a search support model 312, a customer information DB 313, a commodity name DB 314, and a consideration list 315. The search support model 312, the customer information DB 313, the commodity name DB 314, and the consideration list 315 may be stored not only in the storage unit 303 of the management server 30 but also in another device.

The control program 311 is a program for implementing functions of the operating system and the management server 30. The control program 311 includes a program for implementing characteristic functions according to the present embodiment.

The search support model 312 is a trained model trained using known machine learning (including deep learning) techniques, and is used to search for an image related to a target commodity on various SNSs.

For example, the search support model 312 is a trained model that compares characteristics of a commodity image with characteristics of each image on the SNS, calculates indices such as similarity and relevance, and calculates the indices with weighting according to commodity information such as a commodity name, thereby extracting an image that is similar to the commodity image or an image of a related commodity. As an example, the search support model 312 outputs the image similar to the commodity image extracted from various SNSs or the image of the related commodity in response to the input of the commodity image and the commodity name (commodity information).

The commodity information may include a brand name in addition to the commodity image and the commodity name.

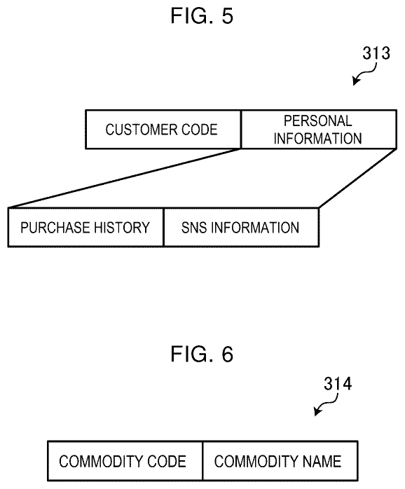

FIG. 5 is a diagram showing an example of a data structure of the customer information data base (DB) 313. The customer information DB 313 is a database having information related to a customer. More specifically, the customer information DB 313 stores a customer code and personal information in association with each other for each customer.

The customer code is identification information for identifying a customer. The personal information is personal information of the customer. For example, a purchase history and SNS information are included.

The purchase history is information indicating a history of commodity purchased by the customer. The SNS information is information indicating an account of an SNS used by the customer. The SNS information may be information indicating an account for each SNS platform for a plurality of SNSs.

The information included in the personal information is not limited to the above example. For example, the personal information may include age and gender of the customer.

FIG. 6 is a diagram showing an example of a data structure of the commodity name DB 314. The commodity name DB 314 is a database related to a commodity name. Specifically, the commodity name DB 314 stores a commodity code and a commodity name in association with each other for each commodity.

The commodity code is identification information for identifying a commodity. The commodity name is a name of a commodity.

The data structure of the commodity name DB 314 is not limited to that shown in FIG. 6. For example, the commodity name DB 314 may store a brand name, a commodity price, or the like of a corresponding commodity in association with a commodity code.

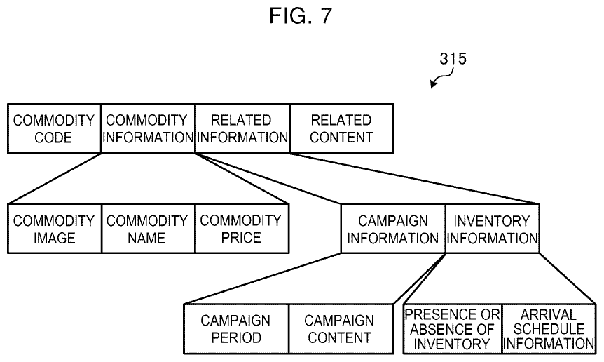

FIG. 7 is a diagram showing an example of a data structure of the consideration list 315. The consideration list 315 is a database having information related to a target commodity that the customer is considering purchasing. Specifically, the consideration list 315 stores, for each target commodity, a commodity code, commodity information, related information, and a related content in association with each other.

The commodity code is identification information for identifying the target commodity. The commodity information is information related to the target commodity. For example, the commodity information includes the commodity image, the commodity name, and the commodity price. The commodity information may include other kinds of information.

The commodity image is an image of the target commodity. The commodity name is a name of the target commodity. The commodity price is a price of the target commodity. The commodity price may be a price of the target commodity in the store designated (or actually visited) by the user or a price of the target commodity in the EC site.

The commodity price may be information indicating the price of the target commodity for each store (EC site) for all stores and EC sites from which the price of the target commodity can be acquired. The commodity price may include information such as a desired retail price of a manufacturer.

The related information is information of a target commodity related to the purchase consideration of the customer. For example, the related information includes campaign information and inventory information. The related information may include other kinds of information.

The campaign information is information related to a campaign of the target commodity. For example, the campaign information includes a campaign period and a campaign content. The campaign information may include other kinds of information.

The campaign period is information indicating a period during which the campaign is performed. The campaign content is information indicating a content of the campaign. Specifically, the campaign content is information indicating the content of the campaign such as an applied condition, a discount at the time of purchase, point redemption at the time of purchase, and a present of a related commodity at the time of purchase.

The inventory information is information of a target commodity related to the inventory of the target commodity. For example, the inventory information includes presence or absence of inventory and arrival schedule information. The inventory information may include other kinds of information.

The presence or absence of inventory is information indicating the presence or absence of the inventory of the target commodity. The presence or absence of inventory may be information indicating presence or absence of inventory in a store designated by the user, or may be information indicating presence or absence of inventory in an EC site.

The presence or absence of inventory may be information indicating the presence or absence of inventory in all stores and EC sites from which information related to inventory can be acquired. In this case, the presence or absence of inventory may include information indicating a store (or EC site) that has the item in stock.

The arrival schedule is information indicating an arrival schedule of the target commodity. For example, the arrival schedule is information indicating when the target commodity is scheduled to arrive when the presence or absence of inventory is absence. The arrival schedule may be information indicating when the target commodity is to be arrived in the store designated by the user or information indicating when the target commodity is to be arrived in the EC site.

The arrival schedule may be information indicating when the target commodity is scheduled to arrive in all stores and the entire EC site from which information related to inventory can be acquired. In this case, the arrival schedule may include information indicating a store (or EC site) that has the arrival schedule.

Returning to FIG. 4, the description will be continued. The communication unit 304 is a communication device such as a network interface card. For example, the communication unit 304 performs communication via the network 50.

The display unit 305 is a display device such as a liquid crystal display or an organic EL display.

The operation unit 306 is an input device that receives various operations from, for example, hardware buttons and a touch panel provided in the display unit 305.

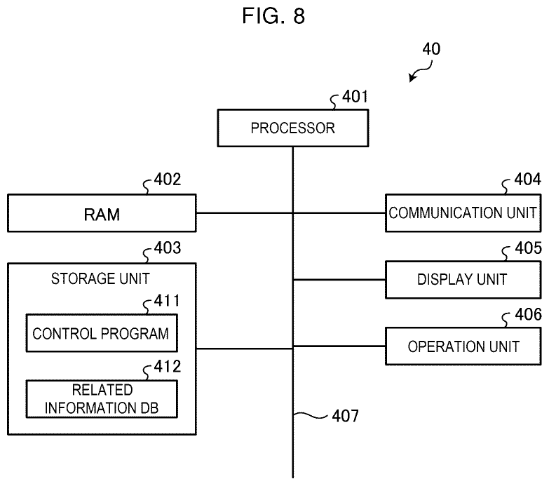

FIG. 8 is a diagram showing an example of a hardware configuration of the store server 40 according to the embodiment. The store server 40 includes a processor 401, a RAM 402, a storage unit 403, a communication unit 404, a display unit 405, and an operation unit 406. These units are connected via an internal bus 407.

The processor 401 is a processing circuit such as a CPU that controls an operation of the store server 40. The RAM 402 is a storage medium that temporarily stores various programs and various types of data. The processor 401 executes a control program 411 and the like stored in the storage unit 403 using the RAM 402 as a work area (working region).

The storage unit 403 is an auxiliary storage device such as an HDD, an SSD, or a flash memory. For example, the storage unit 403 stores the control program 411 and a related information DB 412.

The control program 411 is a program for implementing functions of the operating system and the store server 40. The control program 411 includes a program for implementing characteristic functions according to the present embodiment.

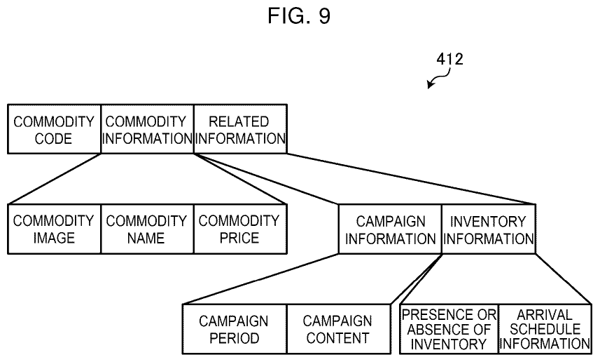

FIG. 9 is a diagram showing an example of a data structure of the related information DB 412. The related information DB 412 is a database including information related to purchase consideration by a customer of a commodity handled in a store (or EC site). Specifically, the related information DB 412 stores, for each commodity handled in the store, a commodity code, commodity information, and related information in association with each other.

Since the commodity code, the commodity information, and the related information are the same as the commodity code, the commodity information, and the related information of the consideration list 315 of FIG. 7, the description thereof will be omitted.

Returning to FIG. 8, the description will be continued. The communication unit 404 is a communication device such as a network interface card. For example, the communication unit 404 performs communication via the network 50.

The display unit 405 is a display device such as a liquid crystal display or an organic EL display.

The operation unit 406 is an input device that receives various operations from, for example, hardware buttons and a touch panel provided in the display unit 405.

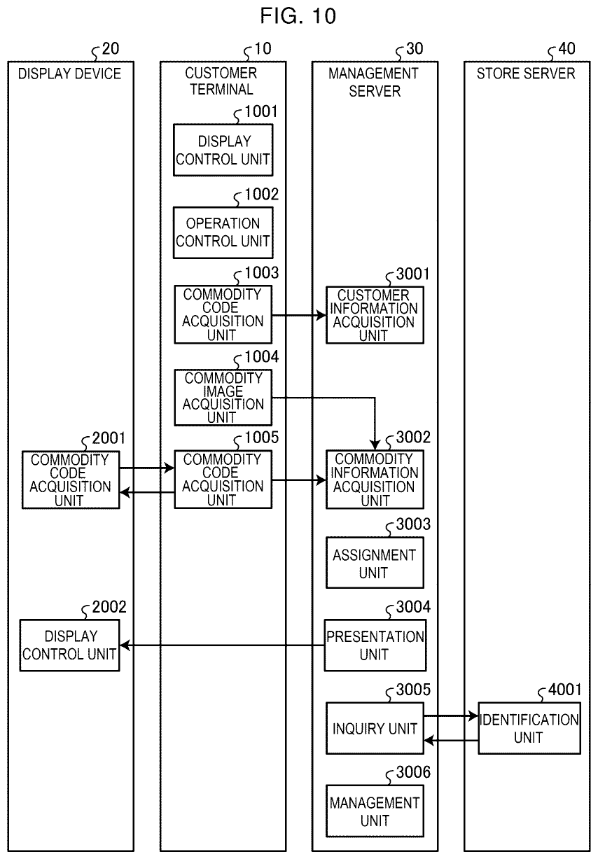

Next, functions of each device of the purchase support system 1 will be described. FIG. 10 is a block diagram showing an example of a functional configuration of each device of the purchase support system 1 according to the embodiment.

The processor 201 included in the display device 20 loads the control program 211 stored in the storage unit 203 into the RAM 202 and operates in accordance with the control program 211 to generate each functional unit in the RAM 202. Accordingly, the processor 201 included in the display device 20 includes a commodity code acquisition unit 2001 and a display control unit 2002 as functional units.

The commodity code acquisition unit 2001 acquires a commodity code for identifying a commodity which is a target of purchase consideration by the customer. For example, the commodity code acquisition unit 2001 controls the RFID reader 207 to acquire the commodity code by receiving the commodity code from the RFID tag attached to the commodity.

Specifically, when receiving a commodity code acquisition instruction from the customer terminal 10, the commodity code acquisition unit 2001 controls the RFID reader 207 to acquire the commodity code by receiving the commodity code from the RFID tag attached to the commodity.

Further, the commodity code acquisition unit 2001 transmits the acquired commodity code to the customer terminal 10 as a response to the commodity code acquisition instruction.

The commodity code acquisition unit 2001 may acquire the commodity code based on a wireless tag other than the RFID tag and a reading device capable of receiving data from the wireless tag.

The commodity code acquisition unit 2001 may include an imaging unit similar to the imaging unit 107 of the customer terminal 10 in the display device 20 and acquire the commodity code from the image data captured by the imaging unit.

For example, the commodity code acquisition unit 2001 may decode a code symbol such as a bar code or a two-dimensional code to acquire a commodity code represented by the code symbol. In addition, for example, the commodity code acquisition unit 2001 may acquire a commodity code represented by numerals or characters by optical character recognition (OCR).

For example, the commodity code acquisition unit 2001 may identify the commodity code based on the commodity included in the image data and correspondence information in which the commodity image and the commodity code are associated with each other. The correspondence information may be stored in an external device or may be stored in the storage unit 203. In this case, the commodity code acquisition unit 2001 may acquire the commodity code by referring to the correspondence information and identifying the commodity code corresponding to the commodity included in the image data.

The commodity code acquisition unit 2001 may acquire the commodity code based on the input of the customer. For example, the commodity code acquisition unit 2001 may acquire the commodity code by an operation received by the operation unit 206.

The display control unit 2002 displays various images on the display unit 205. For example, the display control unit 2002 displays, on the display unit 205, the related content including a related image of a target commodity received from the management server 30.

The processor 101 included in the customer terminal 10 loads the control program 111 stored in the storage unit 103 into the RAM 102, and operates in accordance with the control program 111 to generate each functional unit in the RAM 102. Accordingly, the processor 101 included in the customer terminal 10 includes a display control unit 1001, an operation control unit 1002, a customer code acquisition unit 1003, a commodity image acquisition unit 1004, and a commodity code acquisition unit 1005 as functional units.

The display control unit 1001 displays various images on the display unit 105. For example, the display control unit 1001 displays, on the display unit 105, a graphical user interface (GUI) for instructing various operations related to the purchase support service.

The operation control unit 1002 receives various operations from a customer via the operation unit 106. For example, the operation control unit 1002 receives, from the customer, via the GUI displayed on the display unit 105, an input operation of a customer code for using the purchase support service.

In addition to the above, the operation control unit 1002 may receive, from the customer, an input operation of a password for using the purchase support service. The operation control unit 1002 may receive an input operation of a user name that can uniquely identify a customer instead of the customer code.

The operation control unit 1002 receives an instruction of an operation of adding the target commodity to the consideration list 315 via the GUI. Specifically, the operation control unit 1002 receives, from the customer, a pressing input of a “buy later” button displayed on the display unit 105 together with the information indicating the target commodity.

The customer code acquisition unit 1003 acquires a customer code for identifying a customer. For example, the customer code acquisition unit 1003 acquires a customer code in response to an operation received by the operation control unit 1002.

Specifically, the customer code acquisition unit 1003 acquires the input customer code through a log-in screen displayed on the display unit 105 at the start of use of the purchase support service. The log-in screen is, for example, a screen for receiving from a customer an input of a customer code and a log-in password.

The customer code acquisition unit 1003 may acquire the customer code from the image data captured by the imaging unit 107. For example, the customer code acquisition unit 1003 may decode a code symbol attached to a membership card or the like to acquire a customer code represented by the code symbol. For example, the customer code acquisition unit 1003 may acquire the customer code represented by numerals or characters by the OCR.

Further, the customer code acquisition unit 1003 transmits the acquired customer code to the management server 30.

The customer code may be acquired by the management server 30 instead of the customer terminal 10.

The commodity image acquisition unit 1004 acquires a commodity image for identifying a target commodity. For example, the commodity image acquisition unit 1004 acquires the commodity image based on the image data captured by the imaging unit 107.

Specifically, the commodity image acquisition unit 1004 activates a camera app of the customer terminal 10 when an operation instruction to acquire a commodity image is given from the customer via the GUI displayed on the display unit 105. At this time, the display control unit 1001 may cause the display unit 105 to display a message prompting the customer to image the commodity. Then, the commodity image acquisition unit 1004 acquires, as the commodity image, the image data captured by the imaging unit 107 by the operation of the customer.

The commodity image acquisition unit 1004 may request the customer to approve whether the captured image data may be used as the commodity image.

In this case, the display control unit 1001 causes the display unit 105 to display a message inquiring whether the entire commodity is contained in the captured image data, along with a “Yes” button, and a “No” button. The commodity image acquisition unit 1004 acquires, as the commodity image, the image data captured when the operation control unit 1002 receives a pressing input of the “Yes” button from the customer.

Accordingly, it is possible to prevent an image in which the commodity is not shown or an image in which only a part of the commodity is shown from being acquired as the commodity image.

The commodity code acquisition unit 1005 acquires the commodity code of the target commodity. For example, when the customer issues an operation instruction to acquire the commodity code of the target commodity via the GUI displayed on the display unit 105, the commodity code acquisition unit 1005 transmits a commodity code acquisition instruction to acquire the commodity code to the display device 20. The commodity code acquisition unit 1005 acquires the commodity code transmitted from the display device 20 in response to the commodity code acquisition instruction.

Then, the commodity code acquisition unit 2001 transmits the acquired commodity code to the customer terminal 10.

The commodity code acquisition unit 1005 may acquire the commodity code from the image data captured by the imaging unit 107.

For example, the commodity code acquisition unit 1005 may decode the code symbol to acquire the commodity code represented by the code symbol. For example, the commodity code acquisition unit 1005 may acquire the commodity code represented by numerals or characters by the OCR.

For example, the commodity code acquisition unit 1005 may identify the commodity code based on the commodity included in the image data and correspondence information in which the commodity image and the commodity code are associated with each other. The correspondence information may be stored in an external device or may be stored in the storage unit 103. In this case, the commodity code acquisition unit 1005 may acquire the commodity code by referring to the correspondence information and identifying the commodity code corresponding to the commodity included in the image data.

The commodity code acquisition unit 1005 may acquire the commodity code based on the input of the customer. For example, the commodity code acquisition unit 1005 may acquire the commodity code by an operation received by the operation unit 106.

When the commodity code acquisition unit 1005 can acquire the commodity code without using the display device 20, the display device 20 may not include the commodity code acquisition unit 2001.

The processor 301 included in the management server 30 loads the control program 311 stored in the storage unit 303 into the RAM 302 and operates in accordance with the control program 311 to generate each functional unit in the RAM 302. Accordingly, the processor 301 included in the management server 30 includes a customer information acquisition unit 3001, a commodity information acquisition unit 3002, an assignment unit 3003, a presentation unit 3004, an inquiry unit 3005, and a management unit 3006 as functional units.

The customer information acquisition unit 3001 acquires, from the customer information DB 313, the customer information related to the customer identified by the customer code received from the customer terminal 10. The customer information acquisition unit 3001 is an example of a first acquisition unit. Specifically, the customer information acquisition unit 3001 receives the customer code from the customer terminal 10. The customer information acquisition unit 3001 acquires personal information identified by the received customer code as the customer information.

The commodity information acquisition unit 3002 acquires commodity information related to the target commodity. The commodity information acquisition unit 3002 is an example of a second acquisition unit. For example, the commodity information acquisition unit 3002 acquires the commodity image of the target commodity and the commodity name of the target commodity as commodity information.

Specifically, the commodity information acquisition unit 3002 acquires the commodity image received from the customer terminal 10 as the commodity image of the target commodity. The commodity information acquisition unit 3002 refers to the commodity name DB 314 and identifies the commodity name corresponding to the commodity code received from the customer terminal 10. The commodity information acquisition unit 3002 acquires the commodity name as the commodity name of the target commodity.

The assignment unit 3003 assigns a tag to a content including an image related to a target commodity existing on the SNS. The assignment unit 3003 is an example of a search unit. For example, the assignment unit 3003 uses the search support model 312 to automatically assign a tag (for example, “#commodity name” or “#brand name”) representing a target commodity to an image related to the target commodity existing on the SNS on the management server 30. The assignment unit 3003 may assign a plurality of tags to the content.

Specifically, the assignment unit 3003 inputs the commodity image and the commodity name acquired by the commodity information acquisition unit 3002 to the search support model 312. The assignment unit 3003 automatically assigns the tag such as “#commodity name” to the content on various SNSs including the image output by the search support model 312.

The presentation unit 3004 presents a content including an image related to the target commodity to the customer. For example, the presentation unit 3004 presents, to the customer, a content that is highly likely to be linked to the commodity image requested by the customer among the content to which the tag is assigned by the assignment unit 3003 based on an interest tendency of the customer.

Specifically, the presentation unit 3004 analyzes the interest tendency of the customer based on a purchase history of the commodity of the customer, a search history of an SNS account of the customer, a posting history, and the like by a known natural language processing technique. The presentation unit 3004 evaluates a priority of the content to which the tag is assigned by the assignment unit 3003 based on the interest tendency of the customer. In this case, the presentation unit 3004 is an example of an evaluation unit.

As an example, when the customer is interested in a snowboard, the presentation unit 3004 evaluates the priority so that the content including the image captured while wearing a target commodity (or a related commodity of the target commodity) at a ski resort has a higher priority. The presentation unit 3004 evaluates the priority so that the priority of content including an image captured while wearing the target commodity in town is lower than that of the content including the image captured while wearing the target commodity at the ski resort.

The presentation unit 3004 may evaluate the priority of the content in consideration of information representing attributes of the customer such as age, gender, and body shape of the customer. In this case, information representing the attributes may be added to the personal information of the customer.

As an example, when the customer is a thin and tall female in her 20s, the presentation unit 3004 may evaluate the content including an image in which a person having an attribute similar to the thin and tall female in her 20s wears the target commodity with a higher priority. In addition, the presentation unit 3004 may evaluate the priority of content by weighting the age, the gender, and the body shape.

The presentation unit 3004 may evaluate the priority of the content by weighting the interest tendency of the customer and the attributes of the customer (age, gender, body type, and the like).

After the evaluation of the priority, the presentation unit 3004 selects a predetermined number (for example, five) of contents in descending order of priority from the contents to which the tags are assigned. Further, the presentation unit 3004 transmits the selected content as the related content of the target commodity to the display device 20.

The inquiry unit 3005 inquires of the store server 40 about the related information of the target commodity. For example, when the operation instruction to store the target commodity in the consideration list 315 is received from the customer via the customer terminal 10, the inquiry unit 3005 inquires of the store server 40 about the related information of the target commodity.

Specifically, when the operation control unit 1002 of the customer terminal 10 receives the pressing input of the “buy later” button displayed on the display unit 105 from the customer, a storage instruction including the commodity image acquired by the commodity image acquisition unit 1004 and the commodity code of the target commodity acquired by the commodity code acquisition unit 1005 is transmitted from the customer terminal 10 to the management server 30.

Upon receiving the storage instruction, the inquiry unit 3005 receives an operation instruction to store the target commodity in the consideration list 315. Next, the inquiry unit 3005 transmits, to the store server 40, a related information inquiry including the commodity image and the commodity code of the target commodity. The inquiry unit 3005 receives the related information of the target commodity transmitted as a response to the related information inquiry.

The management unit 3006 manages the consideration list 315. For example, the management unit 3006 stores the related information of the target commodity and the related content presented by the presentation unit 3004 in the consideration list 315.

Specifically, the management unit 3006 stores the commodity code, the commodity information, and the related information associated with the related information of the target commodity received by the inquiry unit 3005 from the store server 40, and the related content transmitted by the presentation unit 3004 to the display device 20 in the consideration list 315 in association with each other.

When the presentation unit 3004 presents the related content, the management unit 3006 may cause the inquiry unit 3005 to transmit the related information inquiry of the target commodity. In this case, the management unit 3006 automatically stores the target commodity in the consideration list 315 without receiving the instruction from the customer.

When an operation instruction to delete the target commodity from the consideration list 315 is received via the customer terminal 10, the management unit 3006 deletes the target commodity from the consideration list 315.

Specifically, when the operation control unit 1002 of the customer terminal 10 receives a pressing input of a “purchased” button or a “stop purchase” button displayed on the display unit 105 together with the information indicating the target commodity from the customer, a deletion instruction including the commodity image acquired by the commodity image acquisition unit 1004 and the commodity code of the target commodity acquired by the commodity code acquisition unit 1005 is transmitted from the customer terminal 10 to the management server 30.

Upon receiving the deletion instruction, the management unit 3006 receives the operation instruction to delete the target commodity from the consideration list 315. Next, the management unit 3006 deletes the information associated with the commodity image and the commodity code included in the deletion instruction from the consideration list 315.

The management unit 3006 may delete the target commodity from the consideration list 315 when a predetermined period (for example, one month after the target commodity is stored in the consideration list 315) elapses.

The management unit 3006 cooperates with the inquiry unit 3005 to periodically update the related information. When the arrival schedule of the target commodity is determined in the store or the EC site in which the arrival schedule of the target commodity is not determined, the management unit 3006 may notify the customer of the arrival schedule via the customer terminal 10. Similarly, when it is determined to perform a new campaign related to the target commodity, the management unit 3006 may notify the customer of the determination.

The processor 401 included in the store server 40 loads the control program 411 stored in the storage unit 403 into the RAM 402 and operates in accordance with the control program 411 to generate each functional unit in the RAM 402. Accordingly, the processor 401 included in the store server 40 includes an identification unit 4001 as a functional unit.

The identification unit 4001 identifies the related information of the target commodity. For example, when the related information inquiry is received from the management server 30, the identification unit 4001 identifies the related information corresponding to the commodity image and the commodity code included in the related information inquiry.

Specifically, the identification unit 4001 refers to the related information DB 412 and identifies the campaign information and the inventory information which are the related information corresponding to the commodity image and the commodity code included in the related information inquiry received from the management server 30. As described above, the campaign information includes the campaign period and the campaign content. The inventory information includes the presence or absence of inventory and the arrival schedule information.

The identification unit 4001 sets the identified campaign information and inventory information as related information of the target commodity, and transmits the commodity code and the commodity information (commodity image, commodity name, and commodity price on the related information DB 412) to the management server 30 in association with each other.

Next, processing executed by each device of the purchase support system 1 will be described.

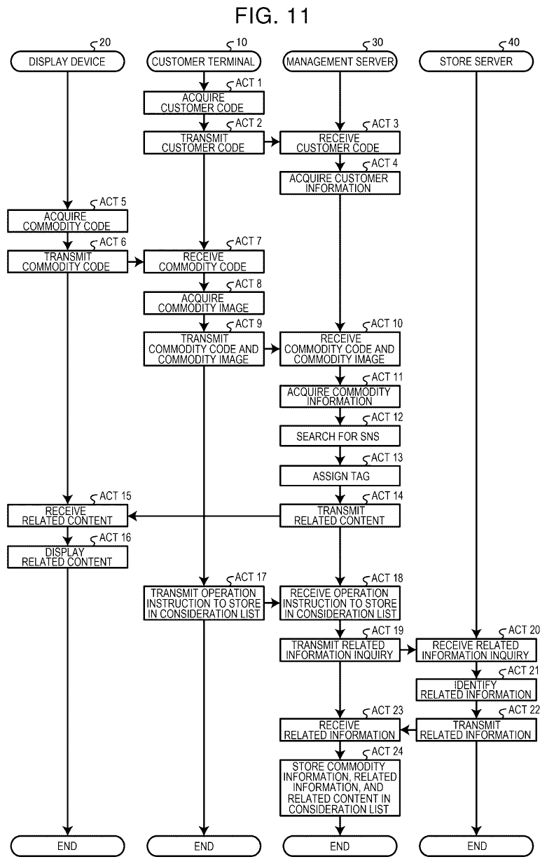

FIG. 11 is a flowchart showing an example of the processing executed by each device of the purchase support system 1 according to the embodiment.

First, the customer code acquisition unit 1003 of the customer terminal 10 acquires a customer code of a customer who uses the purchase support service (Act 1). For example, the customer code acquisition unit 1003 cooperates with the operation control unit 1002 to acquire the customer code input by the customer via the log-in screen displayed on the display unit 105.

Next, the customer code acquisition unit 1003 transmits the customer code to the management server 30 (Act 2). For example, the customer code acquisition unit 1003 transmits the customer code acquired in Act 1 to the management server 30 via the communication unit 104 and the network 50.

Next, the customer information acquisition unit 3001 of the management server 30 receives the customer code (Act 3). For example, the customer information acquisition unit 3001 receives the customer code transmitted from the customer terminal 10 in Act 2 via the communication unit 304 and the network 50.

Next, the customer information acquisition unit 3001 acquires customer information (Act 4). For example, the customer information acquisition unit 3001 refers to the customer information DB 313 and acquires personal information corresponding to the customer code received in Act 3 as the customer information.

Next, the commodity code acquisition unit 2001 of the display device 20 acquires the commodity code of the target commodity (Act 5). For example, when an acquisition instruction of the commodity code is received from the customer terminal 10, the commodity code acquisition unit 2001 acquires the commodity code by causing the RFID reader 207 to receive the commodity code from the RFID tag attached to the target commodity.

Next, the commodity code acquisition unit 2001 transmits the customer code to the customer terminal 10 (Act 6). For example, the commodity code acquisition unit 2001 transmits the commodity code acquired in Act 5 to the customer terminal 10 via the communication unit 204 and the network 50.

Next, the commodity code acquisition unit 1005 of the customer terminal 10 receives the commodity code of the target commodity (Act 7). For example, the commodity code acquisition unit 1005 receives the commodity code transmitted from the display device 20 in Act 6.

Next, the commodity image acquisition unit 1004 acquires a commodity image of the target commodity (Act 8). For example, the commodity image acquisition unit 1004 causes the customer to capture an image of the target commodity by the imaging unit 107, and acquires the captured image data as the commodity image.

Next, the commodity image acquisition unit 1004 transmits the commodity code and the commodity image of the target commodity to the management server 30 (Act 9). For example, the commodity image acquisition unit 1004 transmits the commodity code received in Act 7 and the commodity image acquired in Act 8 to the management server 30.

Next, the commodity information acquisition unit 3002 of the management server 30 receives the commodity code and the commodity image of the target commodity (Act 10). For example, the commodity information acquisition unit 3002 receives the commodity code and the commodity image transmitted from the customer terminal 10 in Act 9.

Next, the commodity information acquisition unit 3002 acquires commodity information of the target commodity (Act 11). For example, the commodity information acquisition unit 3002 refers to the commodity name DB 314 and identifies the commodity name corresponding to the commodity code received in Act 10. The commodity information acquisition unit 3002 acquires the identified commodity name and the commodity image received in Act 10 as the commodity information.

Next, the assignment unit 3003 searches for a content including a related image of the target commodity on the SNS (Act 12). For example, the assignment unit 3003 inputs the commodity name and the commodity image acquired in Act 11 to the search support model 312. The assignment unit 3003 searches for a content including the image output by the search support model 312 on various SNSs.

Next, the assignment unit 3003 assigns a tag to the searched content (Act 13). For example, the assignment unit 3003 assigns a tag such as “#commodity name” to the content including the image searched in Act 12 and output by the search support model 312.

Next, the presentation unit 3004 transmits the related content of the target commodity to the display device 20 (Act 14).

For example, the presentation unit 3004 analyzes the interest tendency of the customer based on a search history or a posting history of an SNS account of the customer included in the customer information. The presentation unit 3004 evaluates the priority of the content to which the tag is assigned based on the interest tendency of the customer. The presentation unit 3004 selects a predetermined number of contents in descending order of priority. The presentation unit 3004 transmits, to the display device 20, the selected predetermined number of contents as the related content.

Next, the display control unit 2002 of the display device 20 receives the related content of the target commodity (Act 15). For example, the display control unit 2002 receives the related content transmitted from the management server 30 in Act 14. Next, the display control unit 2002 displays the received related content on the display unit 205 (Act 16), and the display device 20 ends the present processing.

Next, the operation control unit 1002 of the customer terminal 10 transmits, to the management server 30, an operation instruction to store the target commodity in the consideration list 315 (Act 17), and the customer terminal 10 ends the present processing.

For example, when an input of the operation instruction to store the target commodity in the consideration list 315 is received from the customer via the GUI displayed on the display unit 105, the operation control unit 1002 transmits a storage instruction to store the target commodity in the consideration list 315 to the management server 30. The storage instruction includes the commodity code acquired in Act 5 and the commodity image acquired in Act 8.

Next, the inquiry unit 3005 of the management server 30 receives the operation instruction to store the target commodity in the consideration list 315 (Act 18). For example, the inquiry unit 3005 receives the storage instruction transmitted from the customer terminal 10 in Act 17.

Next, the inquiry unit 3005 transmits a related information inquiry to the store server 40 (Act 19). For example, the inquiry unit 3005 transmits, to the store server 40, the related information inquiry including the commodity code and the commodity image of the target commodity included in the storage instruction received in Act 18.

Next, the identification unit 4001 of the store server 40 receives the related information inquiry (Act 20). For example, the identification unit 4001 receives the related information inquiry transmitted from the management server 30 in Act 19 via the communication unit 404 and the network 50.

Next, the identification unit 4001 identifies related information of the target commodity (Act 21). For example, the identification unit 4001 refers to the related information DB 412 and identifies the campaign information and the inventory information corresponding to the commodity code and the commodity image included in the related information inquiry received in Act 20 as the related information of the target commodity.

Next, the identification unit 4001 transmits the related information of the target information (Act 22), and the store server 40 ends the present processing. For example, the identification unit 4001 transmits the related information of the target commodity identified in Act 21 to the management server 30 in association with the commodity code and the commodity information (the commodity image, the commodity name, and the commodity price on the related information DB 412).

Next, the inquiry unit 3005 of the management server 30 receives the related information of the target commodity (Act 23). For example, the inquiry unit 3005 receives the related information of the target commodity associated with the commodity code and the commodity information transmitted from the store server 40 in Act 22.

Next, the management unit 3006 stores the commodity information, the related information, and the related content of the target commodity in the consideration list 315 (Act 24), and ends the present processing. For example, the management unit 3006 stores, in the consideration list 14, the commodity code, the commodity information, and the related information included in the related information of the target commodity received in Act 23 in association with the related content transmitted to the display device 20 in Act 14.

As described above, the purchase support system 1 according to the first embodiment acquires the customer information including information related to the interest tendency of the customer, acquires the commodity information related to the target commodity which is in purchase consideration of the customer, searches for, based on the commodity information, the related content including an image related to the target commodity from a content existing on the SNS, evaluates a priority of the searched related content based on the customer information, and presents the related content to the customer according to the priority.

Accordingly, the purchase support system 1 can present, to the customer, the related content including the image related to the target commodity matching the interest tendency of the customer. Generally, when the SNS is searched using an image or a name of a commodity, an enormous number of contents are displayed as a search result, and the customer may not obtain an image close to an image desired by the customer. In contrast, since the purchase support system 1 according to the present embodiment can present, to the customer, the related content including the image related to the target commodity matching the interest tendency of the customer, the customer is highly likely to be provided with the content including the image close to the image desired by the customer. That is, according to the purchase support system 1 according to the present embodiment, it is possible to efficiently support a customer who is a consumer in acquiring a specific commodity image.

The above-described embodiment can be appropriately modified and implemented by changing a part of the configuration or function of each of the devices. Hereinafter, some modifications according to the above-described embodiment will be described as other embodiments.

Hereinafter, points different from the above-described embodiment will be mainly described, and detailed description of points common to the already described contents will be omitted. In addition, modifications described below may be individually implemented or may be implemented in combination as appropriate.

### Modification 1

In the above-described embodiment, the purchase support system 1 includes both the customer terminal 10 and the display device 20. In the present modification, the purchase support system 1 includes only one of the customer terminal 10 and the display device 20.

First, a case in which the purchase support system 1 includes only the customer terminal 10 among the customer terminal 10 and the display device 20 will be described. In this case, the customer terminal 10 acquires a commodity code of a target commodity.

For example, the display control unit 1001 causes the display unit 105 to display a message prompting the customer to image a code symbol representing the commodity code attached to the target commodity by the imaging unit 107. Further, the commodity code acquisition unit 1005 acquires the commodity code by decoding the code symbol imaged by the imaging unit 107 according to the operation of the customer.

A wireless tag of a standard readable by a near field communication (NFC) reader mounted on the customer terminal 10 may be attached to the commodity. In this case, the commodity code acquisition unit 1005 acquires the commodity code of the target commodity by receiving the commodity code from the wireless tag attached to the target commodity by the NFC reader.

The presentation unit 3004 of the management server 30 transmits the related content of the target commodity to the customer terminal 10. The display control unit 1001 of the customer terminal 10 causes the display unit 105 to display the related content of the target commodity.

Next, a case in which the purchase support system 1 includes only the display device 20 among the customer terminal 10 and the display device 20 will be described. In this case, the display device 20 includes an imaging unit. The display device 20 includes, as functional units, the operation control unit 1002, the customer code acquisition unit 1003, and the commodity image acquisition unit 1004, in addition to the commodity code acquisition unit 2001 and the display control unit 2002.

For example, the display control unit 2002 according to the present modification causes the display unit 205 to display a GUI for receiving various operation instructions. The operation control unit 1002 receives various operations from a customer via the operation unit 206. For example, the operation control unit 1002 receives an input operation related to the use of the purchase support service from the customer via the GUI displayed on the display unit 205.

The customer code acquisition unit 1003 acquires a customer code in response to an operation received by the operation control unit 1002. For example, the customer code acquisition unit 1003 acquires the input customer code through a log-in screen displayed on the display unit 205 at the start of use of the purchase support service.

The commodity image acquisition unit 1004 activates a camera app installed in the display device 20 when an operation instruction to acquire a commodity image is given from the customer via the GUI displayed on the display unit 205. Then, the commodity image acquisition unit 1004 acquires, as the commodity image, image data captured by the imaging unit of the display device 20 by the operation of the customer.

When an operation instruction to acquire the commodity code of the target commodity is given from the customer through the GUI displayed on the display unit 105, the commodity code acquisition unit 2001 acquire the commodity code of the target commodity in the same manner as in the above-described embodiment.

According to the present modification, the purchase support service can be provided to the customer with a simpler system configuration.

### Modification 2

In the embodiment described above, the customer terminal 10 receives the input of the customer code, and the management server 30 acquires the customer information based on the customer code. In the present modification, a form in which the management server 30 acquires the customer information based on a face image of a customer imaged by the customer terminal 10 will be described.

The customer information DB 313 of the storage unit 303 of the management server 30 according to the present modification stores, in addition to a customer code and personal information, the face image in association with the customer code and the personal information. The customer information DB 313 may not store the face image itself, but may store characteristic information of the face image in association with the customer code and the personal information.

In the present modification, the customer terminal 10 causes the customer to capture the face image of the customer using the imaging unit 107. The customer terminal 10 transmits the captured face image of the customer to the management server 30.

The customer information acquisition unit 3001 of the management server 30 receives the face image of the customer captured by the imaging unit 107 of the customer terminal 10. Next, the customer information acquisition unit 3001 refers to the customer information DB 313 and identifies the customer code and the personal information corresponding to the received face image (or the characteristic information of the face image). Then, the customer information acquisition unit 3001 acquires the identified customer code and personal information as the customer information.

According to the present modification, since the customer code and the personal information corresponding to the face image are acquired as the customer information, even when the customer code of the customer is known to a person other than the customer, it is possible to prevent a situation in which the person uses the purchase support service as the customer.

The program executed by each device in the embodiment and the modifications described above is provided by being incorporated in advance in a storage medium (the ROM or the storage unit) provided in each device, but is not limited thereto. For example, the program may be provided by being recorded in a computer-readable recording medium such as a CD-ROM, a flexible disk (FD), a CD-R, or a digital versatile disk (DVD) in a file in an installable or executable format. Further, the storage medium is not limited to a medium independent of the computer or an incorporation system, and also includes a storage medium in which a program transmitted by a LAN, the internet, or the like is stored or temporarily stored by being downloaded.

The program executed by each device in the embodiment and the modifications described above may be stored in a computer connected to a network such as the Internet and provided by being downloaded via the network, or may be provided or distributed via the network such as the Internet.

While certain embodiments have been described, the embodiment has been presented by way of example only and is not intended to limit the scope of the exemplary embodiments. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. An information processing system, comprising:
a first acquisition component configured to acquire customer information including information related to an interest tendency of a customer;
a second acquisition component configured to acquire commodity information related to a target commodity in a purchase consideration of the customer;
a search component configured to search for, based on the commodity information, a related content including an image related to the target commodity from a plurality of contents including images stored in an external device;
an evaluation component configured to evaluate a priority of the related content from a search based on the customer information; and
a presentation component configured to present the related content to the customer according to the priority.

2. The information processing system according to claim 1, wherein
the evaluation component evaluates the priority of the related content to be higher as the related content includes an image related to the interest tendency.

3. The information processing system according to claim 2, wherein
the customer information includes information representing an attribute of the customer, and
the evaluation component evaluates the priority of the related content to be higher as the related content includes an image of a person having an attribute similar to the attribute of the customer.

4. The information processing system according to claim 3, wherein
the evaluation component performs weighting according to a degree of importance of each of the interest tendency and the attribute of the customer to evaluate the priority.

5. The information processing system according to claim 1, further comprising:
a display controller configured to display the presented related content on a display device.

6. The information processing system according to claim 5, wherein
the display device is provided in a store that handles the target commodity.

7. The information processing system according to claim 1, wherein
the customer information comprises at least one of purchase history of the customer, SNS information of the customer, age of the customer, and gender of the customer.

8. The information processing system according to claim 1, wherein
the search component is a trained search support model using machine learning techniques to search for the image related to the target commodity on a plurality of SNSs.

9. The information processing system according to claim 1, wherein
the search component is a search support model that compares characteristics of a commodity image with characteristics of each image on the SNS, calculates indices of similarity and relevance, calculates indices with weighting according to the commodity information, and then extracts the image that is similar to the commodity image or an image of a related commodity.

10. The information processing system according to claim 1, wherein
the commodity information comprises at least one of a brand name, a color of the commodity, and a price of the commodity.

11. An information processing method, comprising:
a first acquisition component configured to acquire customer information including information related to an interest tendency of a customer;
a second acquisition component configured to acquire commodity information related to a target commodity in a purchase consideration of the customer;
a search component configured to search for, based on the commodity information, a related content including an image related to the target commodity from a plurality of contents including images stored in an external device;
an evaluation component configured to evaluate a priority of the related content from a search based on the customer information; and
a presentation component configured to present the related content to the customer according to the priority.

12. The information processing method according to claim 11, further comprising:
evaluating the priority of the related content to be higher as the related content includes an image related to the interest tendency.

13. The information processing method according to claim 12, wherein
the customer information includes information representing an attribute of the customer, and further comprising:
evaluating the priority of the related content to be higher as the related content includes an image of a person having an attribute similar to the attribute of the customer.

14. The information processing method according to claim 13, further comprising:
weighting according to a degree of importance of each of the interest tendency and the attribute of the customer to evaluate the priority.

15. The information processing method according to claim 11, further comprising:
displaying the presented related content on a display device.

16. The information processing method according to claim 15, wherein
the display device is provided in a store that handles the target commodity.

17. The information processing method according to claim 11, wherein
the customer information comprises at least one of purchase history of the customer, SNS information of the customer, age of the customer, and gender of the customer.

18. The information processing method according to claim 11, further comprising:
using machine learning techniques to search for the image related to the target commodity on a plurality of SNSs.

19. The information processing method according to claim 11, further comprising:
comparing characteristics of a commodity image with characteristics of each image on the SNS;
calculating indices of similarity and relevance;
calculating indices with weighting according to the commodity information; and then
extracting the image that is similar to the commodity image or an image of a related commodity.

20. The information processing method according to claim 11, wherein
the commodity information comprises at least one of a brand name, a color of the commodity, and a price of the commodity.
